(19) United States
(12) Patent Application Publication
(10) Pub. No.: US 2021/0399305 A1
(43) Pub. Date: Dec. 23, 2021

(54) A PROTECTIVE BARRIER LAYER FOR ALKALINE BATTERIES

(71) Applicant: URBAN ELECTRIC POWER INC., Pearl River, NY (US)

(72) Inventors: Jinchao HUANG, Pearl River, NY (US); Sanjoy BANERJEE, Pearl River, NY (US); Alexander COUZIS, Pearl River, NY (US); Andrew NAUKAM, Pearl River, NY (US); Michael NYCE, Pearl River, NY (US)

(21) Appl. No.: 17/287,928

(22) PCT Filed: Oct. 24, 2019
(86) PCT No.: PCT/US2019/057844

§ 371 Date: Apr. 22, 2021

Related U.S. Application Data
(60) Provisional application No. 62/750,038, filed on Oct. 24, 2018.

(51) Int. Cl. H01M 4/62; H01M 10/28

(52) U.S. Cl. CPC H01M 4/62; H01M 4/244; H01M 10/286

(57) ABSTRACT

An alkaline battery comprises an anode, a cathode, a separator disposed between the anode and the cathode, a barrier layer disposed between the anode and the cathode, and an electrolyte in fluid communication with the anode, the cathode, and the separator. The barrier layer is at least one of: an organic polymer film or a porous inorganic layer or combinations thereof.

### CROSS-REFERENCE TO RELATED APPLICATIONS

This application claims the benefit of U.S. Provisional Application No. 62/750,038 filed on Oct. 24, 2018 and entitled “A Protective Barrier Layer for Alkaline Batteries,” which is incorporated herein by reference in its entirety for all purposes.

### STATEMENT REGARDING GOVERNMENTALLY SPONSORED RESEARCH OR DEVELOPMENT

Not applicable.

### BACKGROUND

This disclosure relates to batteries including electrochemical cells. Alkaline cells have been predominantly used as primary batteries. However, the one-time use of primary batteries results in large material wastage as well as undesirable environmental consequences. Also, potential economic losses can arise due to the significant imbalance between the energy that is required to manufacture these cells compared to the energy that can be actually stored. As a consequence, there is a clear advantage to provide rechargeable or secondary cells.

As a form of alkaline cells, zinc-anode batteries have dominated the primary battery market since its invention. However, the rechargeable version of this chemistry has met with only limited success. This is in part due to various problems with short cycle life and electrical shorts that can occur with alkaline cells using zinc anodes.

### SUMMARY

In some embodiments, an alkaline battery comprises an anode, a cathode, a separator disposed between the anode and the cathode, a barrier layer disposed between the anode and the cathode, and an electrolyte in fluid communication with the anode, the cathode, and the separator. The barrier layer is at least one of: an organic polymer film or a porous inorganic layer or combinations thereof.

In some embodiments, an anode comprises an electrode material comprising zinc, and a barrier layer disposed on the electrode material. The barrier layer is at least one of: an organic polymer film or a porous inorganic layer or combinations thereof.

In some embodiments, a method of forming a battery comprises providing an electroactive material, disposing a barrier layer on the electroactive material, and disposing the electroactive material with the barrier layer in a housing to form the battery. The barrier layer is at least one of: an organic polymer film or a porous inorganic layer or combinations thereof.

These and other features will be more clearly understood from the following detailed description taken in conjunction with the accompanying claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 schematically illustrates a battery according to an embodiment.

FIG. 2 schematically illustrates an electrode according to an embodiment.

FIG. 3 schematically illustrates another battery according to another embodiment.

FIG. 4 illustrates an electrode having a barrier layer disposed thereon according to an embodiment.

### DESCRIPTION

In this disclosure, the terms “negative electrode” and “anode” are both used to mean “negative electrode.” Likewise, the terms “positive electrode” and “cathode” are both used to mean “positive electrode.” Reference to an “electrode” alone can refer to the anode, cathode, or both. Reference to the term “primary battery” (e.g., “primary battery,” “primary electrochemical cell,” or “primary cell”), refers to a cell or battery that after a single discharge is disposed of and replaced. Reference to the term “secondary battery” (e.g., “secondary battery,” “secondary electrochemical cell,” or “secondary cell”), refers to a cell or battery that can be recharged one or more times and reused.

The use of zinc in alkaline cells is becoming attractive for large-scale energy storage applications because of the low cost and good safety characteristics of the basic material, as well as its high theoretical energy density. However, the rechargeable version of this chemistry has met with only limited success. The Zn electrode is known to face a problem of short and unpredictable cycle life during charge and discharge cycling, especially at a high utilization. Various failure mechanisms of Zn electrode have been reported, the major problems being the electrode shape change, dendritic morphology growth and passivation of the electrode surface. The origin of these phenomena can be traced to the dissolution-precipitation reaction pathway of Zn during charge-discharge cycling. The rapid electrochemical kinetics and the poor electrolyte accessibility are mainly responsible for Zn electrode degradation. In addition, an unpredictable cell failure in its early life is also a problem with the current cell design, which is mainly caused by electrical shorts associated with exposed current collectors that can cut the separator through.

Disclosed herein is a barrier layer which is inexpensive, inert and stable in the electrolyte, highly hydrophilic for easy electrolyte accessibility, and mechanically strong to prevent electrical short circuits. The present devices and methods relate to methods for making protective barrier layers in a battery, methods for laminating such barrier layer with electrodes, and methods for laminating such barrier layer with other separator films. Alkaline batteries containing such barriers and electrodes are also described.

Disclosed herein are inexpensive protective barrier layers (e.g., films, coatings, etc.) for application in alkaline batteries. This barrier layer can be inert and stable in the electrolyte for long-term use. The barrier layer can be highly hydrophilic, and enable an electrolyte reservoir at the electrode surface, which mitigates electrode degradation by maintaining a supply of electrolyte throughout the discharge/charge cycling. The barrier layer can provide enhanced tortuosity to disrupt dendritic growth and support the performance of the regular separator membranes. The barrier layer can fully cover one or more of the electrodes and can be sufficiently mechanically strong to prevent the exposed current collector from cutting through the regular membrane to prevent the electrical short circuits from happening.

In some embodiments, a method includes selecting an organic material for the barrier layer. The materials can include, but are not limited to, polyethylene, polypropylene, polyester, polyamide, cellulose acetate, cellophane, polyvinyl chloride, and polyvinyl alcohol. In an embodiment, a method can also include selecting an inorganic material for the barrier layer. The materials can include, but are not limited to, ceramic materials and/or films such as zeolites, Nasicons, Lithicons, and inorganic films made with water insoluble metal oxide, metal hydroxide, and layered double hydroxide(s).

In some embodiments, a method of forming an electrode and cell can include laminating the electrode with the barrier. The electrode can be the anode, the cathode, or both. The laminating process can be carried out by using a heated laminator, by winding the electrode sheet with the barrier layer, and/or by coating the electrode with a dispersion containing the barrier material.

In some embodiment, a method can include laminating the barrier layer with the separator films. The materials of the separator films can include, but are not limited to, polyethylene, polypropylene, polyester, polyamide, cellulose acetate, cellophane, polyvinyl chloride, and polyvinyl alcohol. The laminating methods include but are not limited to, using a heated laminator, by winding the barrier layer with the separators, and/or by coextrusion of the films.

In an embodiment, a method for making a battery comprises a cathode, an anode, and a separator disposed between the anode and the cathode. At least one of the electrodes is laminated with a layer of the layer film.

These and other features will be more clearly understood from the following detailed description taken in conjunction with the accompanying claims.

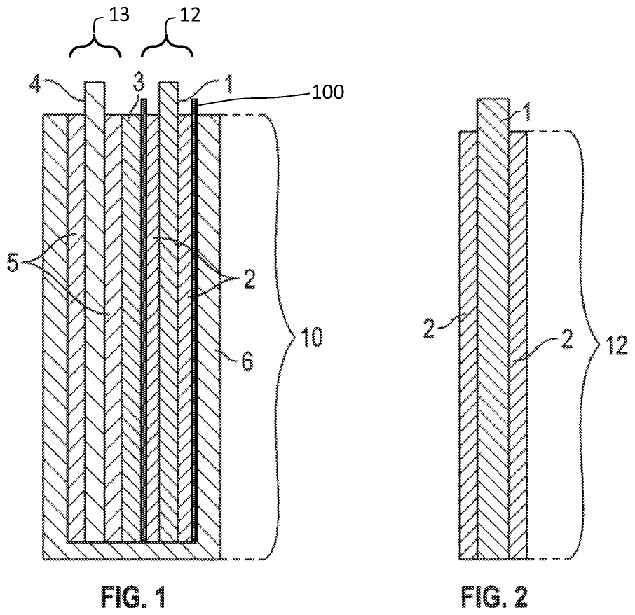

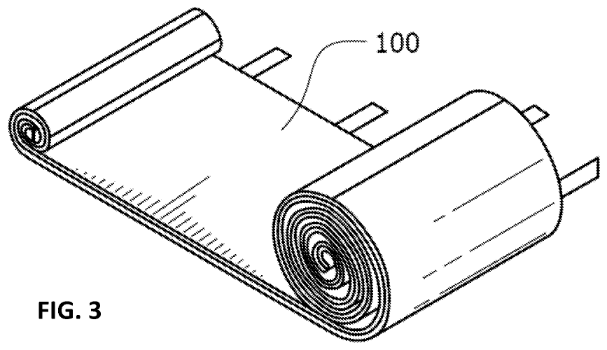

Referring to FIG. 1, a battery 10 has a housing 6, a cathode current collector 1, a cathode material 2, a separator 3, an anode current collector 4, and an anode material 5. FIG. 1 shows a prismatic battery arrangement. In another embodiment, the battery can be a cylindrical battery (e.g., as shown in FIG. 3) having the electrodes arranged concentrically or in a rolled configuration in which the anode and cathode are layered and then rolled to form a jellyroll configuration. An electrolyte can be dispersed in an open space throughout battery 10. The cathode current collector 1 and cathode material 2 are collectively called either the cathode 12 or the positive electrode 12, as shown in FIG. 2. Similarly, the anode current collector 4 and the anode material 5 are collectively called either the anode 13 or the negative electrode 13.

In some embodiments, the battery 10 can comprise one or more cathodes 12 and one or more anodes 13. When a plurality of anodes 13 and/or cathodes 12 are present, the electrodes can be configured in a layered configuration such that the electrodes alternate (e.g., anode, cathode, anode, etc.). Any number of anodes 13 and/or cathodes 12 can be present to provide a desired capacity and/or output voltage.

The cathode 12 can comprise a mixture of components including an electrochemically active material, a binder, a conductive material, and one or more additional components that can serve to improve the lifespan, rechargeability, and electrochemical properties of the cathode 12. The cathode 12 can be incorporated into the battery 10. The cathode can comprise an active cathode material (e.g., an electroactive material). Suitable materials can include, but are not limited to, manganese oxide, manganese dioxide, copper manganese oxide, hausmannite, manganese oxide, copper intercalated bismuth birnessite, birnessite, todokorite, ramsdellite, pyrolusite, pyrochroite, nickel hydroxide, sintered nickel, nickel oxyhydroxide, potassium permanganate, cobalt oxide, silver oxide, silver, lithium manganese oxide, lithium manganese nickel cobalt oxide, lithium iron phosphate, copper oxide, manganese oxide, lithium vanadium phosphate, vanadium phosphate, vanadium pentoxide, nickel, copper, copper hydroxide, lead, lead hydroxide, lead oxide, or a combination thereof. In some embodiments, the cathode can be an air electrode and/or carbon electrode.

In some embodiments, the active cathode material can based on one or many polymorphs of MnO₂, including electrolytic (EMD), α-MnO₂, β-MnO₂, γ-MnO₂, δ-MnO₂, ε-MnO₂, or λ-MnO₂. Other forms of MnO₂ can also be present such as pyrolusite, ramsdellite, nsutite, manganese oxyhydroxide (MnOOH), α-MnOOH, γ-MnOOH, β-MnOOH, manganese hydroxide [Mn(OH)₂], partially or fully protonated manganese dioxide, Mn₃O₄, Mn₂O₃, bixbyite, MnO, lithiated manganese dioxide, zinc manganese dioxide. In general the cycled form of manganese dioxide in the cathode can have a layered configuration, which in some embodiment can comprise δ-MnO₂ that is interchangeably referred to as birnessite. If non-birnessite polymorphic forms of manganese dioxide are used, these can be converted to birnessite in-situ by one or more conditioning cycles as described in more details below. For example, a full or partial discharge to the end of the MnO₂ second electron stage (e.g., between about 20% to about 100% of the 2^{nd} electron capacity of the cathode) may be performed and subsequently recharging back to its Mn⁴⁺ state, resulting in birnessite-phase manganese dioxide.

The addition of a conductive additive such as conductive carbon enables high loadings of an electroactive material in the cathode material, resulting in high volumetric and gravimetric energy density. The conductive carbon can be present in a concentration between about 1-30 wt %. Such conductive carbon include single walled carbon nanotubes, multi-walled carbon nanotubes, graphene, carbon blacks of various surface areas, and others that have specifically very high surface area and conductivity. Higher loadings of the electroactive material in the cathode are, in some embodiments, desirable to increase the energy density. Other examples of conductive carbon include TIMREX Primary Synthetic Graphite (all types), TIMREX Natural Flake Graphite (all types), TIMREX MB, MK, MX, KC, B, LB Grades (examples, KS15, KS44, KC44, MB15, MB25, MK15, MK25, MK44, MX15, MX25, BNB90, LB family) TIMREX Dispersions; ENASCO 150G, 210G, 250G, 260G, 350G, 150P, 250P; SUPER P, SUPER P Li, carbon black (examples include Ketjenblack EC-300J, Ketjenblack EC-600JD, Ketjenblack EC-600JD powder), acetylene black, carbon nanotubes (single or multi-walled), carbon nanotubes plated with metal like nickel and/or copper, graphene, graphyne, graphene oxide, Zenyatta graphite, and combinations thereof. When the electroactive material comprises manganese, the birnessite discharge reaction comprises a dissolution-precipitation reaction where Mn³⁺ ions become soluble and precipitate out on the conductive carbon as Mn²⁺. This second electron process involves the formation of a non-conductive manganese hydroxide [Mn(OH)₂] layer on the conductive graphite.

The conductive additive can have a particle size range from about 1 to about 50 microns, or between about 2 and about 30 microns, or between about 5 and about 15 microns. In an embodiment, the conductive additive can include expanded graphite having a particle size range from about 10 to about 50 microns, or from about 20 to about 30 microns. In some embodiments, the mass ratio of graphite to the conductive additive can range from about 5:1 to about 50:1, or from about 7:1 to about 28:1. The total carbon mass percentage in the cathode paste can range from about 5% to about 30% or between about 10% to about 20%.

The addition of a conductive component such as metal additives to the cathode material may be accomplished by addition of one or more metal powders such as nickel powder to the cathode mixture. The conductive metal component can be present in a concentration of between about 0-30 wt %. The conductive metal component may be, for example, nickel, copper, silver, gold, tin, cobalt, antimony, brass, bronze, aluminum, calcium, iron or platinum. In one embodiment, the conductive metal component is a powder. In one embodiment, a second conductive metal component is added to act as a supportive conductive backbone for the first and second electron reactions to take place. The second electron reaction has a dissolution-precipitation reaction where Mn³⁺ ions become soluble in the electrolyte and precipitate out on the graphite resulting in an electrochemical reaction and the formation of manganese hydroxide [Mn(OH)₂] which is non-conductive. This ultimately results in a capacity fade in subsequent cycles. Suitable second component include transition metals like Ni, Co, Fe, Ti and metals like Ag, Au, Al, Ca. Salts of such metals are also suitable. Transition metals like Co also help in reducing the solubility of Mn³⁺ ions. Such conductive metal components may be incorporated into the electrode by chemical means or by physical means (e.g. ball milling, mortar/pestle, spex mixture). An example of such an electrode comprises 5-95% birnessite, 5-95% conductive carbon, 0-50% second conductive metal component and 1-10% binder.

In some embodiments a binder can be used in the cathode material. The binder can be present in a concentration of between about 0-10 wt % of the cathode material. In some embodiments, the binder comprises water-soluble cellulose-based hydrogels, which were used as thickeners and strong binders, and have been cross-linked with good mechanical strength and with conductive polymers. The binder may also be a cellulose film sold as cellophane. The binders were made by physically cross-linking the water-soluble cellulose-based hydrogels with a polymer through repeated cooling and thawing cycles. In one embodiment, 0-10 wt. % carboxymethyl cellulose (CMC) solution was cross-linked with 0-10 wt. % polyvinyl alcohol (PVA) on an equal volume basis. The binder, compared to the traditionally-used TEFLON®, shows superior performance. TEFLON® is a very resistive material, but its use in the industry has been widespread due to its good rollable properties. This, however, does not rule out using TEFLON® as a binder. Mixtures of TEFLON® with the aqueous binder and some conductive carbon were used to create rollable binders. Using the aqueous-based binder helps in achieving a significant fraction of the two electron capacity with minimal capacity loss over many cycles. In one embodiment, the binder is water-based, has superior water retention capabilities, adhesion properties, and helps to maintain the conductivity relative to an identical cathode using a TEFLON® binder instead. Examples of hydrogels include methyl cellulose (MC), carboxymethyl cellulose (CMC), hydroypropyl cellulose (HPH), hydroypropylmethyl cellulose (HPMC), hydroxethylmethyl cellulose (HEMC), carboxymethylhydroxyethyl cellulose and hydroxyethyl cellulose (HEC). Examples of crosslinking polymers include polyvinyl alcohol, polyvinylacetate, polyaniline, polyvinylpyrrolidone, polyvinylidene fluoride and polypyrrole. In one such embodiment, a 0-10 wt % solution of water-cased cellulose hydrogen is cross linked with a 0-10% wt solution of crosslinking polymers by, for example, repeated freeze/thaw cycles, radiation treatment or chemical agents (e.g. epichlorohydrin). The aqueous binder may be mixed with 0-5% TEFLON® to improve manufacturability.

Additional elements can be included in the cathode material including a bismuth compound and/or copper/copper compounds, which together allow improved galvanostatic battery cycling of the cathode. When present as birnessite, the copper and/or bismuth can be incorporated into the layered nanostructure of the birnessite. The resulting birnessite cathode material can exhibit improved cycling and long term performance with the copper and bismuth incorporated into the crystal and nanostructure of the birnessite.

The cathodes 12 can be produced using methods implementable in large-scale manufacturing. For a MnO₂ cathode, the cathode 12 can be capable of delivering the full second electron capacity of 617 mAh/g of the MnO₂. Excellent rechargeable performance can be achieved for both low and high loadings of MnO₂ in the mixed material, allowing the cell/battery to achieve very high practical energy densities.

The cathode material 2 can be formed on a cathode current collector 1 formed from a conductive material that serves as an electrical connection between the cathode material and an external electrical connection or connections. In some embodiments, the cathode current collector 1 can be, for example, nickel, steel (e.g., stainless steel, etc.), nickel-coated steel, nickel plated copper, tin-coated steel, copper plated nickel, silver coated copper, copper, magnesium, aluminum, tin, iron, platinum, silver, gold, titanium, half nickel and half copper, or any combination thereof. The cathode current collector may be formed into a mesh (e.g., an expanded mesh, woven mesh, etc.), perforated metal, foam, foil, perforated foil, wire screen, a wrapped assembly, or any combination thereof. In some embodiments, the current collector can be formed into or form a part of a pocket assembly. A tab (e.g., a portion of the cathode current collector 1 extending outside of the cathode material 2 as shown at the top of the cathode 12 in FIG. 1A) can be coupled to the current collector to provide an electrical connection between an external source and the current collector.

In some embodiments, the cathode material 2 can be adhered to the cathode current collector 1 by pressing at, for example, a pressure between 1,000 psi and 20,000 psi (between 6.9×10⁶ and 1.4×10⁸ Pascals). The cathode material 2 may be adhered to the cathode current collector 1 as a paste in some embodiments and/or as a film of cathode material.

The battery 10 can also comprise an anode 13 having an anode material 5 in electrical contact with an anode current collector 4. In some embodiments, the anode material (e.g., the electroactive component) can comprise zinc, aluminum, lithium, magnesium, selenium, or any combination thereof. In some embodiments, the anode material 5 can comprise zinc, which can be present as elemental zinc and/or zine oxide. In some embodiments, the zinc anode can be in the form of a Zn metal foil, a Zn mesh, a perforated Zn metal foil. In some embodiments, the Zn anode mixture comprises Zn, zinc oxide (ZnO), an electronically conductive material, and a binder. The Zn may be present in the anode material 5 in an amount of from about 50 wt. % to about 90 wt. %, alternatively from about 60 wt. % to about 80 wt. %, or alternatively from about 65 wt. % to about 75 wt. %, based on the total weight of the anode material. In an embodiment, Zn may be present in an amount of about 85 wt. %, based on the total weight of the anode material. Additional elements that can be in the anode in addition to the zinc or in place of the zinc include, but are not limited to, lithium, aluminum, magnesium, iron, cadmium and a combination thereof.

In some embodiments, ZnO may be present in an amount of from about 5 wt. % to about 20 wt. %, alternatively from about 5 wt. % to about 15 wt. %, or alternatively from about 5 wt. % to about 10 wt. %, based on the total weight of anode material. In an embodiment, ZnO may be present in anode material in an amount of about 10 wt. %, based on the total weight of the anode material. As will be appreciated by one of skill in the art, and with the help of this disclosure, the purpose of the ZnO in the anode mixture is to provide a source of Zn during the recharging steps, and the zinc present can be converted between zinc and zinc oxide during charging and discharging phases.

In an embodiment, an electrically conductive material may be present in the anode material in an amount of from about 5 wt. % to about 20 wt. %, alternatively from about 5 wt. % to about 15 wt. %, or alternatively from about 5 wt. % to about 10 wt. %, based on the total weight of the anode material. In an embodiment, the electrically conductive material may be present in anode material in an amount of about 10 wt. %, based on the total weight of the anode material. As will be appreciated by one of skill in the art, and with the help of this disclosure, the electrically conductive material is used in the Zn anode mixture as a conducting agent, e.g., to enhance the overall electric conductivity of the Zn anode mixture. Nonlimiting examples of electrically conductive material suitable for use in this disclosure include any of the conductive carbons described herein such as carbon, graphite, graphite powder, graphite powder flakes, graphite powder spheroids, carbon black, activated carbon, conductive carbon, amorphous carbon, glassy carbon, and the like, or combinations thereof. The conductive material can also comprise any of the conductive carbon materials described with respect to the cathode material including, but not limited to, acetylene black, single walled carbon nanotubes, multi-walled carbon nanotubes, graphene, graphyne, or any combinations thereof.

The anode material may also comprise a binder. Generally, a binder functions to hold the electroactive material particles (e.g., Zn used in anode, etc.) together and in contact with the current collector. The binder is present in a concentration of 0-10 wt %. The binders may comprise water-soluble cellulose-based hydrogels like methyl cellulose (MC), carboxymethyl cellulose (CMC), hydroypropyl cellulose (HPH), hydroypropylmethyl cellulose (HPMC), hydroxethylmethyl cellulose (HEMC), carboxymethylhydroxyethyl cellulose and hydroxyethyl cellulose (HEC), which were used as thickeners and strong binders, and have been cross-linked with good mechanical strength and with conductive polymers like polyvinyl alcohol, polyvinylacetate, polyaniline, polyvinylpyrrolidone, polyvinylidene fluoride and polypyrrole. The binder may also be a cellulose film sold as cellophane. The binder may also be TEFLON®, which is a very resistive material, but its use in the industry has been widespread due to its good rollable properties.

In some embodiments, the binder may be present in anode material in an amount of from about 2 wt. % to about 10 wt. %, alternatively from about 2 wt. % to about 7 wt. %, or alternatively from about 4 wt. % to about 6 wt. %, based on the total weight of the anode material. In an embodiment, the binder may be present in anode material in an amount of about 5 wt. %, based on the total weight of the anode material.

A current collector 4 can be used with an anode 13, including any of those described with respect to the cathode 12. The anode material 5 can be pressed onto the anode current collector 4 to form the anode 13. For example, the anode and/or the cathode materials can be adhered to a corresponding current collector by pressing at, for example, a pressure between 1,000 psi and 20,000 psi (between 6.9×10⁶ and 1.4×10⁸ Pascals). The cathode and anode materials may be adhered to the current collector as a paste. A tab of each current collector, when present, can extend outside of the device to form the current collector tab.

In some embodiments, the anode material 5 can be adhered to the anode current collector 4 by pressing at, for example, a pressure between 1,000 psi and 20,000 psi (between 6.9×10⁶ and 1.4×10⁸ Pascals). The anode material 5 may be adhered to the anode current collector 4 as a paste in some embodiments and/or as a film of cathode material.

In some embodiments, a separator can be disposed between the anode 13 and the cathode 12 when the electrodes are constructed into the battery. The separator 3 may comprise one or more layers. Suitable layers can include, but are not limited to, a polymeric separator layer such as a sintered polymer film membrane, polyolefin membrane, a polyolefin nonwoven membrane, a cellulose membrane, a battery-grade cellophane, a hydrophilically modified polyolefin membrane, and the like, or combinations thereof. As used herein, the phrase “hydrophilically modified” refers to a material whose contact angle with water is less than 45°. In another embodiment, the contact angle with water is less than 30°. In yet another embodiment, the contact angle with water is less than 20°. The polyolefin may be modified by, for example, the addition of TRITON X-100™ or oxygen plasma treatment. In some embodiments, the separator 3 can comprise a CELGARD® brand microporous separator. In an embodiment, the separator 3 can comprise a FS 2192 SG membrane, which is a polyolefin nonwoven membrane commercially available from Freudenberg, Germany. In some embodiments, the separator can comprise a lithium super ionic conductor (LISICON®), sodium super ionic conductions (NASICON), NAFION®, a bipolar membrane, water electrolysis membrane, a composite of polyvinyl alcohol and graphene oxide, polyvinyl alcohol, crosslinked polyvinyl alcohol, or a combination thereof. In some embodiments, the separator membranes may be membranes fabricated from nylon, polyester, polyethylene, polypropylene, poly(tetrafluoroethylene) (PTFE), poly(vinyl chloride) (PVC), polyvinyl alcohol, cellulose or combinations thereof.

Within the battery, an electrolyte can be present between the anode and the cathode. In some embodiments, the electrolyte can comprise an alkaline electrolyte (e.g. an alkaline hydroxide, such as NaOH, KOH, LiOH, ammonium hydroxide, or mixtures thereof). In some embodiments, the electrolyte can comprise an acidic solution, alkaline solution, ionic liquid, organic-based, solid-phase, gelled, etc. or combinations thereof that conducts proton, hydroxide, lithium, magnesium, aluminum and zinc ions. Examples include chlorides, sulfates, sodium hydroxide, potassium hydroxide, lithium hydroxide, ammonium hydroxide, perchlorates like lithium perchlorate, magnesium perchlorate, aluminum perchlorate, lithium hexafluorophosphate, [M⁺][AlCl⁴⁻](M⁺)]-sulphonyl chloride or phosphoryl chloride cations, 1-ethyl-3-methylimidazolium bis (trifluoromethyl sulfonyl)imide, 1-ethyl-3-methylimidazolium trifluoromethanesulfonate, 1-butly-1-methylpyrrolidinium bis(trifluoromethyl sulfonyl)imide, 1-hexyl-3-methylimidazolium hexofluorophosphate, 1-ethyl-3-methylimidazolium dicyanamide, 11-methyl-3-octylimidazolium tetrafluoroborate, yttria-stabilized zirconia, beta-alumina solid, polyacrylamides, NASICON, lithium salts in mixed organic solvents like 1,2-dimethoxyethane, propylene carbonate, magnesium bis(hexamethyldisilazide) in tetrahydrofuran and a combination thereof. In some embodiments, the electrolyte can comprise manganese sulfate, manganese chloride, manganese nitrate, manganese perchlorate, manganese acetate, manganese bis(trifluoromethanesulfonate), manganese triflate, manganese carbonate, manganese oxalate, manganese fluorosilicate, manganese ferrocyanide, manganese bromide, nitric acid, sulfuric acid, hydrochloric acid, sodium sulfate, potassium sulfate, sodium hydroxide, sodium hydroxide with dissolved zincate ions, potassium hydroxide, potassium hydroxide with dissolved zincate ions potassium permanganate, titanium sulfate, titanium chloride, lithium nitrate, lithium chloride, lithium bromide, lithium bicarbonate, lithium acetate, lithium sulfate, lithium permanganate, lithium nitrate, lithium nitrite, lithium hydroxide, lithium hydroxide with dissolved zincate ions, lithium perchlorate, lithium oxalate, lithium fluoride, lithium carbonate, lithium bromate, zinc sulfate, zinc chloride, zinc acetate, zinc carbonate, zinc chlorate, zinc fluoride, zinc formate, zinc nitrate, zinc oxalate, zinc sulfite, zinc tartrate, zinc cyanide, zinc oxide, or a combination thereof. The pH of the electrolyte can vary from 0-15.

In some embodiments, the battery 10 can comprise at least one layer of the protective barrier layer 100. The barrier layer 100 can be electrically insulating and chemically resistant to the battery environment. For example, the barrier layer 100 can be resistant to degradation in the electrolyte used in the battery 10. The barrier layer 100 can be designed with highly open structures to allow rapid transport of ions for a minimal electrolyte resistance. The barrier layer can also be designed to be selectively impermeable to chemical components such as zincate ions to mitigate the formation of dendrites, which can lead to shorting of the cells. In addition, the barrier layer 100 can be mechanically strong to prevent any electrical short circuits caused by exposed current collectors that can cut or pierce the barrier layer and any separators.

In some embodiments, the barrier layer 100 can comprise organic and/or inorganic materials. For example, the barrier layer can comprise an organic polymer film and/or a porous inorganic layer. Suitable organic materials include, but are not limited to, polyethylene, polypropylene, polyester, polyamide, cellulose acetate, cellophane, polyvinyl chloride, polyvinyl alcohol, or any combination thereof. Suitable inorganic materials can include, but are not limited to, ceramic films such as zeolites, Nasicons (e.g., sodium superionic conductors), Lithicons (lithium superionic conductors), and combinations thereof, and/or inorganic layers containing water insoluble metal oxides, metal hydroxide, layered double hydroxides, and combinations thereof. The organic materials and the inorganic materials can each be used individually, or in some embodiments, the materials can be layered and/or mixed to form one or layers having both organic and inorganic materials in the barrier layer. The barrier layer can have a thickness ranging from about 0.5 μm to about 5 mm, or between about 1 μm to about 1 mm.

In some embodiments, the poly(vinyl alcohol) (PVA) film is used as a polymer barrier layer. PVA is highly hydrophilic and a good film-forming polymer. PVA consists of a polymer matrix that swells with water and alkaline electrolytes, and thus provides a high ionic conductivity and easy electrolyte accessibility to the electrode. A PVA film can be cold water soluble, hot water soluble, or cross-linked water insoluble. The PVA molecule in the PVA used in the barrier layer can vary from a molecular weight as low as 5,000 g/mol to as high as 500,000 g/mol, and its degree of hydrolysis can vary from about 70% to about 99+%.

In some embodiments, each battery 10 or cell can contain at least one layer of a separator membrane that can be used to block any dendrites forming on the anode. In some embodiments, a plurality of layers of cellophane (e.g., 1-10 layers, 1-5 layers, etc.) can be used together with the barrier layer as a separator package to provide protection to the anode, the cathode, or both. In some embodiments, a plurality of layers (e.g., 1-10 layers, 1-5 layers, etc.) of cold water soluble PVA film or hot water soluble PVA film are used together as the separator combination.

The barrier layer 100 can be incorporated into the battery in a number of ways. In some embodiments, the barrier layer 100 may be produced as a separate layer (e.g., a freestanding film, etc.) and added to the battery as a film during construction of the battery 10. The barrier layer 100 may be laminated with the electrodes by using a heated laminator or by winding the electrode sheet together with the barrier layer, which can be in the form of a film and/or coating. The barrier layer can be laminated with the anode, the cathode, or both.

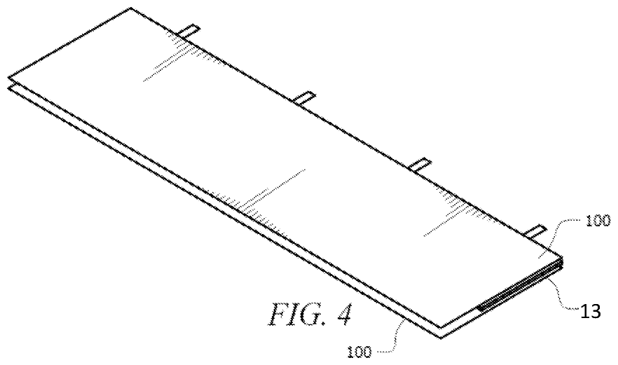

FIG. 4 illustrates an embodiment of a barrier layer 100 disposed on each side of an anode 13. In some embodiments, a layer of the barrier layer 100 can be laminated onto each side of the anode surface with a heated laminator. The high temperature is usually used to soften the barrier layer film and to achieve a better lamination to the electrode surface. The temperature used for lamination may vary from 20° C. to 100° C. The whole electrode sheet can be fully covered by the barrier layer 100, leaving extra length of film on the leading and trailing edges, and on the top and bottom of the electrode 13. The edges of the barrier layer 100 maybe heat sealed or folded around the edges of the electrode, or just left open. While shown as being layered on the anode 13, the barrier layer 100 can also or alternatively be layered on the cathode 12 in the same manner as the anode 13.

In some embodiments, the barrier layer 100 may be laminated with one or more separator membranes as well. The separator membranes can include any of those described herein. The laminating methods include but are not limited to by using a heated laminator, by winding the barrier layer with the separators, or by coextrusion of the films. The temperature used for lamination may also vary from 20° C. to 100° C. to soften the films but not to melt them. When separator membranes are used with the electrode(s) in addition to the barrier layer, the barrier layer can be disposed on or in contact with the surface of the electrode (e.g., in direct contact with the electrode surface)

In some embodiments, the barrier layer 100 may be added to or disposed on one or more electrodes in the battery 10 as a coated layer. For a coating of the barrier layer, the starting barrier material comprising the organic and/or inorganic material may be first dispersed in a solvent to form a dispersion. The dispersion can then be used to coat an electrode and/or a separator membrane. Any suitable solvent that can sufficiently solvate the material of the barrier layer can be used. In some embodiments, the solvent can be water or organic solvent including but not limited to ethanol, acetone, propanol, butanol, hexane and benzene. The coating process maybe carried out by solution casting, spray coating, dip coating, or by using a doctor-blade film coater. The coating process can result in a coating of the dispersion on one or more surfaces of an electrode and/or a separator membrane. Once disposed on the electrode and/or separator, the coating layer can be dried to remove the solvent and leave behind the barrier layer 100. When the dispersion is used with a separator membrane, the resulting separator membrane can then be used to cover or wrap the electrode. In general, the separator can be disposed on the electrode so that the resulting barrier layer is in contact with the electrode surface. One or more layering techniques can be used to obtain the desired barrier layer with a desired thickness.

In some embodiments, the barrier layer can be applied as multiple layers. Each layer can have the same or a different composition. For example, multiple barrier layers can be used in which one layer comprises an organic material as described herein, and a second layer can comprise an inorganic material as described herein. Additional layers can further be used with or without separator membranes.

Once the battery is formed having at least one barrier layer disposed therein, the battery 10 can then be used in a primary or secondary battery. When used as a secondary battery, the battery 10 can be cycled during use by being charged and discharged.

### EXAMPLES

The embodiments having been generally described, the following examples are given as particular embodiments of the disclosure and to demonstrate the practice and advantages thereof. It is understood that the examples are given by way of illustration and are not intended to limit the specification or the claims in any manner.

### Example 1

An alkaline Zn/MnO₂ cylindrical cell was fabricated. One layer of cold water soluble PVA film was laminated onto each side of the anode surface with a heated laminator. The anode sheet was fully covered by the PVA film, leaving about 1 inch of film on the leading and trailing edges, and 0.5 inch on the top and bottom of the anode. Three layers of cellophane were applied in the separator package as well, serving as extra barriers for dendrites. A jelly roll was made by winding the PVA-laminated anode sheet, the cellophane and the cathode sheet together. 25 wt % KOH solution was used as the electrolyte.

Early failure tests were carried out by running cells at 20% depth of discharge (DOD). Cells were discharged with a constant current of 10 A. Cells failed in less than 15 cycles were regarded as early failure and the percentage of failure was calculated accordingly.

Table 1 compares the failure percentages of cells without PVA and cells with PVA laminated anodes. While a failure percentage as high as 20.84% was observed in the non-PVA cells, most of which were associated with damage caused by exposed current collectors, laminating the anodes with a PVA layer helps with preventing such damage, and reduces the early failure to 5.90%.

TABLE 1
Early failure statistics

| Separator | # Cells tested | # Cells failed < 15 cycles | % Failure |
|---|---|---|---|
| Without PVA | 1118 | 233 | 20.84% |
| With cold water soluble | 305 | 18 | 5.90% |
| PVA laminated anodes | | | |

### Example 2

Addition of a PVA film is also beneficial for the cell's long-term cycling. It provides enhanced tortuosity to disrupt dendritic growth and so support the performance of the cellophane. The PVA film also enables an electrolyte reservoir at the anode surface, which reduces long-term degradation by maintaining a supply of electrolyte throughout the discharge/charge cycle. Table 2 summarizes the result of cycle life tests (200 Ah full capacity) of cells with cold water soluble PVA laminated anodes. It is seen that cells cycled at 15% DOD of the 1^{st} electron capacity of MnO₂ at room temperature are able to achieve around 345 cycles, and cells cycled at 20% DOD (40 Ah) have achieved more than 200 cycles.

TABLE 2
Performances of cells containing PVA laminated anodes

| | | | Average # cycles |
|---|---|---|---|
| Temperature | Discharge capacity | # cells tested | before capacity fade |
| 28° C. | 30 Ah | 2 | 345 |
| 28° C. | 40 Ah | 8 | 262 |
| 28° C. | 60 Ah | 2 | 180 |
| 28° C. | 100 Ah | 1 | 40 |
| 40° C. | 40 Ah | 3 | 110 |

Having described various electrodes, processes, and devices, specific embodiments can include, but are not limited to:

In a first embodiment, an alkaline battery comprises: an anode; a cathode; a separator disposed between the anode and the cathode; a barrier layer; and an electrolyte in fluid communication with the anode, the cathode, and the separator.

A second embodiment can include the alkaline battery of the first embodiment, wherein the barrier layer can be an organic polymer film or a porous inorganic layer or combinations thereof.

A third embodiment can include the alkaline battery of the second embodiment, wherein the organic polymer film comprises at least one of polyethylene, polypropylene, polyester, polyamide, cellulose acetate, cellophane, polyvinyl chloride, and polyvinyl alcohol, or combinations thereof.

A fourth embodiment can include the alkaline battery of the second or third embodiment, wherein the inorganic layer comprises at least one of the ceramic films including but not limited to Zeolites, Nasicons and Lithicons or combinations thereof.

A fifth embodiment can include the alkaline battery of any one of the second to fourth embodiments, wherein the inorganic layer comprises at least one of the water-insoluble metal hydroxides, metal layered double hydroxides, metal oxides or combinations thereof.

A sixth embodiment can include the alkaline battery of any one of the first to fifth embodiments, wherein the barrier layer is produced individually and applied as a freestanding film in the battery.

A seventh embodiment can include the alkaline battery of any one of the first to sixth embodiments, wherein the barrier layer is applied by coating the anode, the cathode or the separator with a dispersion of the barrier material.

An eighth embodiment can include the alkaline battery of the seventh embodiment, wherein the solvent for the dispersion can be water or organic solvent including but not limited to ethanol, acetone, propanol, butanol, hexane and benzene.

A ninth embodiment can include the alkaline battery of the seventh or eighth embodiment, wherein the coating process is carried out by solution casting, spray coating, dip coating, or by using a doctor-blade film coater.

A tenth embodiment can include the alkaline battery of any one of the first to ninth embodiments, wherein at least one layer of the barrier is applied.

An eleventh embodiment can include the alkaline battery of any one of the first to tenth embodiments, wherein the thickness of the barrier layer varies from 1 μm to 1 mm.

A twelfth embodiment can include the alkaline battery of any one of the first to eleventh embodiments, wherein the barrier layer is configured to: cover the exposed current collector and protect the cell from electrical short circuit; provide an electrolyte reservoir for easy electrolyte accessibility; and suppress the transport of zincate ions.

A thirteenth embodiment can include the alkaline battery of any one of the first to twelfth embodiments, wherein at least one layer of the barrier is laminated with one or more separator membranes.

A fourteenth embodiment can include the alkaline battery of the thirteenth embodiment, wherein the separator membranes are films fabricated from nylon, polyester, polyethylene, polypropylene, poly(tetrafluoroethylene) (PTFE), poly(vinyl chloride) (PVC), polyvinyl alcohol, cellulose or combinations thereof.

A fifteenth embodiment can include the alkaline battery of the thirteenth or fourteenth embodiment, wherein the barrier layer is laminated with the separator membranes by hot pressing, by a laminator, by coextrusion, by winding or by coating.

A sixteenth embodiment can include the alkaline battery of any one of the first to fifteenth embodiments, wherein the barrier layer is laminated with the anode or the cathode or both.

A seventeenth embodiment can include the alkaline battery of the sixteenth embodiment, where in the barrier layer is laminated with the electrodes by hot pressing, by a laminator, by winding or by coating.

An eighteenth embodiment can include the alkaline battery of any one of the first to seventeenth embodiments, wherein the battery can be a prismatic battery or a cylindrical battery.

A nineteenth embodiment can include the alkaline battery of any one of the first to eighteenth embodiments, wherein the battery can be a primary battery or a rechargeable battery.

A twentieth embodiment can include the alkaline battery of any one of the first to nineteenth embodiments, wherein the anode comprises a pasted porous Zn electrode, a Zn metal foil, a Zn mesh, a perforated Zn metal foil.

A twenty first embodiment can include the alkaline battery of any one of the first to twentieth embodiments, wherein the cathode comprises a manganese dioxide electrode, a nickel oxyhydroxide electrode, a silver oxide electrode, and an air electrode.

Embodiments are discussed herein with reference to the Figures. However, those skilled in the art will readily appreciate that the detailed description given herein with respect to these figures is for explanatory purposes as the systems and methods extend beyond these limited embodiments. For example, it should be appreciated that those skilled in the art will, in light of the teachings of the present description, recognize a multiplicity of alternate and suitable approaches, depending upon the needs of the particular application, to implement the functionality of any given detail described herein, beyond the particular implementation choices in the following embodiments described and shown. That is, there are numerous modifications and variations that are too numerous to be listed but that all fit within the scope of the present description. Also, singular words should be read as plural and vice versa and masculine as feminine and vice versa, where appropriate, and alternative embodiments do not necessarily imply that the two are mutually exclusive.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims may be formulated in this Application or of any further Application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any Claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicant(s) hereby give notice that new claims may be formulated to such features and/or combinations of such features during the prosecution of the present Application or of any further Application derived therefrom.

What is claimed is:

1. An alkaline battery comprising:
an anode;
a cathode;
a separator disposed between the anode and the cathode;
a barrier layer disposed between the anode and the cathode, wherein the barrier layer is at least one of: an organic polymer film or a porous inorganic layer or combinations thereof; and
an electrolyte in fluid communication with the anode, the cathode, and the separator.

2. The alkaline battery of claim 1, wherein the organic polymer film comprises at least one of polyethylene, polypropylene, polyester, polyamide, cellulose acetate, cellophane, polyvinyl chloride, and polyvinyl alcohol, or any combination thereof.

3. The alkaline battery of claim 1, wherein the inorganic layer comprises at least one of the ceramic films including but not limited to Zeolites, Nasicons, Lithicons, or any combination thereof.

4. The alkaline battery of claim 1, wherein the inorganic layer comprises at least one of the water-insoluble metal hydroxides, metal layered double hydroxides, metal oxides, or any combination thereof.

5. The alkaline battery of claim 1, wherein the barrier layer comprises a freestanding film in the battery.

6. The alkaline battery of claim 1, wherein the barrier layer comprises at least one layer between the anode and the cathode.

7. The alkaline battery of claim 1, wherein the barrier layer has a thickness between 1 μm to 1 mm.

8. The alkaline battery of claim 1, wherein the barrier layer is configured to:
cover the exposed current collector and protect the cell from electrical short circuit;
provide an electrolyte reservoir for easy electrolyte accessibility; and
suppress the transport of zincate ions.

9. The alkaline battery of claim 1, wherein the battery comprises a plurality of layers of the separator, and wherein the barrier layer is laminated with the plurality of barrier layers on the anode or the cathode.

10. The alkaline battery of claim 9, wherein the separator is a film fabricated from nylon, polyester, polyethylene, polypropylene, poly(tetrafluoroethylene) (PTFE), poly(vinyl chloride) (PVC), polyvinyl alcohol, cellulose, or any combination thereof.

11. The alkaline battery of claim 1, wherein the battery is a prismatic battery or a cylindrical battery.

12. The alkaline battery of claim 1, wherein the anode comprises a pasted porous Zn electrode, a Zn metal foil, a Zn mesh, or a perforated Zn metal foil.

13. The alkaline battery of claim 1, wherein the cathode comprises a manganese dioxide electrode, a nickel oxyhydroxide electrode, a silver oxide electrode, or an air electrode.

14. An anode comprising:
an electrode material comprising zinc; and
a barrier layer disposed on the electrode material, wherein the barrier layer is at least one of: an organic polymer film or a porous inorganic layer or combinations thereof.

15. The anode of claim 14, wherein the barrier layer is laminated on the electrode material.

16. The anode of claim 14, wherein the barrier layer seals around the electrode material.

17. The anode of claim 14, wherein the barrier layer comprises at least one layer of polyvinyl alcohol polymer.

18. The anode of claim 14, wherein the organic polymer film comprises at least one of polyethylene, polypropylene, polyester, polyamide, cellulose acetate, cellophane, polyvinyl chloride, and polyvinyl alcohol, or any combination thereof.

19. The anode of claim 14, wherein the inorganic layer comprises at least one of the ceramic films including but not limited to Zeolites, Nasicons, Lithicons, or any combination thereof.

20. The anode of claim 14, wherein the inorganic layer comprises at least one of the water-insoluble metal hydroxides, metal layered double hydroxides, metal oxides, or any combination thereof.

21. A method of forming a battery, the method comprising:
providing an electroactive material;
disposing a barrier layer on the electroactive material; and
disposing the electroactive material with the barrier layer in a housing to form the battery.

22. A method of claim 21, wherein the electroactive material comprises an anode material, and wherein disposing the barrier layer on the electroactive material comprises:
coating a barrier material on the anode material; and
forming the barrier layer on the anode material based on the coating.

23. The method of claim 22, wherein coating the barrier material on the anode material comprises:
forming a dispersion of the barrier material in a solvent;
coating the dispersion on the anode material;
removing the solvent from the dispersion on the anode material; and
forming the barrier layer on the anode material in response to removing the solvent from the dispersion on the anode material.

24. The method of claim 23, wherein the solvent for the dispersion is water or an organic solvent, wherein the organic solvent comprises ethanol, acetone, propanol, butanol, hexane, benzene, or any combination thereof.

25. The method of claim 23, wherein the coating of the dispersion material is carried out by solution casting, spray coating, dip coating, or by using a doctor-blade film coater.

26. The method of claim 21, wherein disposing the barrier layer on the electroactive material comprises laminating the barrier layer on the electroactive material.

27. The method of claim 26, further comprising:
laminating one or more layers of a separator on the barrier layer.

28. The method of claim 27, wherein the separator is a film fabricated from nylon, polyester, polyethylene, polypropylene, poly(tetrafluoroethylene) (PTFE), poly(vinyl chloride) (PVC), polyvinyl alcohol, cellulose, or any combination thereof.

29. The method of claim 28, wherein the barrier layer is laminated with the separator membranes by hot pressing, by a laminator, by coextrusion, by winding, or by coating.
